(19) United States
(12) Patent Application Publication
(10) Pub. No.: US 2026/0258256 A1
(43) Pub. Date: Sep. 3, 2026

(54) LATEX POLYMER DISPERSION AND THE AQUEOUS COATING COMPOSITION PREPARED FROM THE SAME

(71) Applicant: SPECIALTY OPERATION FRANCE, Lyon (FR)

(72) Inventors: Chunying Liu, Shanghai (CN); Rong Er Lin, Singapore (SG)

(73) Assignee: SPECIALTY OPERATION FRANCE, Lyon (FR)

(21) Appl. No.: 19/489,219

(22) PCT Filed: May 31, 2023
(86) PCT No.: PCT/CN2023/097310

§ 371 Date: Dec. 1, 2025

(51) Int. Cl. C09D 5/02; C08F 212/08; C09D 125/14

(52) U.S. Cl. CPC C09D 5/022; C08F 212/08; C09D 5/024; C09D 125/14; C08F 2800/20

(57) ABSTRACT

The present invention relates to a latex prepared from functional monomers M1 and M2, with improved reaction stability and storage stability. In addition, the present invention further relates to an aqueous coating composition prepared from the same, which has improved freeze thaw stability while maintains wet scrub resistance, particularly substantially free of freeze-thaw additives.

### FIELD OF THE INVENTION

The present invention relates to a latex prepared from functional monomers M1 and M2, with improved reaction stability and storage stability. In addition, the present invention further relates to an aqueous coating composition prepared from the same, which has improved freeze thaw stability while maintains wet scrub resistance, particularly substantially free of freeze-thaw additives.

### BACKGROUND OF THE INVENTION

Latex coating compositions have captured a significant portion of the indoor and outdoor paint market as a result of the many advantages that such paints have over solvent-based products. The main advantage of latex coating compositions include easy clean up, low odor and fast dry.

Although these advantages, latex coating compositions have a deficiency in wet scrub resistance. The term “wet scrub resistance” is used in the paint industry to describe the ability of a paint coating to resist erosion when scrubbed.

In the meantime, latex coating compositions are recognized as being potentially unstable when exposed to freeze-thaw cycles. That is, repeated freezing and warming of latex coating compositions can frequently lead to destabilization of the dispersed polymer in the latex (causing gel formation, for example). This, of course, is a significant problem since these coating compositions are expected to be exposed to a wide range of temperatures during shipment and storage. For this reason, various freeze-thaw additives have been formulated into latex coating compositions in order to improve their resistance to such temperature cycles. Traditionally, these additives have included relatively low molecular weight compounds such as alcohols, glycols and the like.

In recent years, however, such low molecular weight freeze-thaw additives have come under scrutiny since many are classified as volatile organic compounds (VOCs). Environmental regulations in many locations limit the level of VOCs that can be present in coating compositions. For this reason, there has been an effort to develop various new formulations that qualify as zero or low VOC yet still meet the freeze-thaw stability requirements expected in the industry. However, formulating a low VOC, freeze-thaw stable coating composition often compromises other important characteristics of the aqueous coating composition such as wet scrub resistance.

Much effort has been devoted in the past to solve the above problems once for all. U.S. Pat. No. 5,610,225 disclose a latex paint which are free of volatile coalescents and freeze-thaw additives by using polymerizable polyethylene glycol (PPEG) monomer. WO 2020/010509 disclose an aqueous dispersion of multi-stage polymeric particles comprising a polymer and an oligomer which serve as a freeze-thaw additive.

Notwithstanding the above-described prior art techniques, there continues to be a need to identify new latex and coating formulations, especially in the form of paints, which provide balanced wet scrub resistance and freeze thaw stability.

### SUMMARY OF THE INVENTION

In one aspect of the present invention, it is provided a latex polymer dispersion prepared from the monomer composition comprising anionic monomer M1 and alkoxylated (meth)acrylate monomer M2. By the combination of the two monomers, the latex polymer dispersion not only shows favorable reaction stability and storage stability, but also impart improved freeze thaw stability to the aqueous coating composition prepared therefrom while maintains wet scrub resistance.

In another aspect of the present invention, it is provided an aqueous coating formulation with improved freeze thaw stability while maintains wet scrub resistance, particularly substantially free of volatile freeze-thaw additives.

### DETAILED DESCRIPTION OF THE INVENTION

The articles “a”, “an” and “the” are used to refer to one or to more than one (i.e., to at least one) of the grammatical object of the article.

The term “and/or” includes the meanings “and”, “or” and also all the other possible combinations of the elements connected to this term.

As used herein, the term “alkyl” means an aliphatic hydrocarbon group that can be straight or branched and comprises 1 to about 24 carbon atoms in the chain. Branched” means that one or more lower alkyl groups such as methyl, ethyl or propyl, are attached to a linear alkyl chain.

As used herein, the term “alkenyl” means an unsaturated straight chain, branched chain, or cyclic hydrocarbon radical that contains one or more carbon-carbon ethylenically unsaturated bonds, such as, for example, ethenyl, 1-propenyl, 2-propenyl.

As used herein, the terminology “(Cn-Cm)” in reference to an organic group, wherein n and m are each integers, indicates that the group may contain from n carbon atoms to m carbon atoms per group.

As used herein, the term “ethylenically unsaturated” means a terminal (that is, e.g., alpha, beta) carbon-carbon ethylenically unsaturated bond.

As used herein, the term “wet scrub resistance”, which is used in the paint industry to describe the ability of a paint coating to resist erosion when scrubbed. Wet scrub resistance of a coating is notably tested according to Standard GBT 9266.

As used herein, the term “latex” is in its conventional meaning, i.e. a dispersion of particulate matter in an aqueous phase which contains an emulsifier or surfactant suitable for preparing the latex.

As used herein, the term “coating composition” includes and is not limited to latex binders, resins, glues, adhesives which include and are not limited to pressure sensitive adhesives, inks which include and are not limited to UV inks, conventional inks, hybrid inks, and water-based inks, sealants, cement compositions, coatings which include and are not limited to paints.

As used herein, the term “substrate” means an article or a material which is subject to coatings or paints, such as paper, wood, concrete, metal, glass, ceramics, plastics, plaster, an asphaltic coating, a roofing felt, foamed polyurethane insulation, or a previously painted, primed, undercoated, worn, or weathered article.

As used herein, the term “pigment” is a coloring agent that is practically insoluble in the application medium under the pertaining ambient conditions.

### Latex Polymer Dispersion

In one aspect of the present invention, it is provided a latex polymer dispersion prepared by free radical polymerization from a monomer composition comprising:
a) an anionic monomer M1 comprising at least one ethylenically unsaturated bond and at least one anion;
b) an alkoxylated (meth)acrylate monomer M2 represent by formula I)

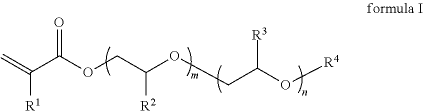

wherein R¹ is selected from H or methyl;
R² is selected from H, C₁-C₄ alkyl;
R³ is selected from C₁-C₄ alkyl, and R² is different from R³;
R⁴ is selected from C₆-C₂₀ alkyl, or C₆-C₂₀ alkenyl, preferably selected from C₈-C₂₀ alkyl or C₆-C₂₀ alkenyl, more preferably C₁₀-C₂₀ alkyl or C₆-C₂₀ alkenyl;
m is a number ranging from 15 to 60, preferably 20 to 60, more preferably 25 to 60;
n is a number ranging from 0 to 10, preferable 0 to 5, more preferably 0 to 3;
m+n is a number ranging from 15 to 60; and
c) an ethylenically unsaturated monomer selected from acrylic acid, methacrylic acid, acrylate ester, methacrylate ester, styrene, vinyl acetate, C₄-C₈ conjugated dienes, vinyl chloride, acrylonitrile, methacrylonitrile, ureido methacrylate, itaconic acid or ester, crotonic acid or ester, maleic acid or ester, fumaric acid or ester, and ethylene or the combination thereof.

The latex polymer dispersion of the invention are particularly advantageous for use in aqueous coating compositions. The advantage of these dispersion is that they show favorable reaction stability and storage stability. In addition, can be used to formulate latex coating compositions which require substantially no freeze-thaw additive, such as ethylene glycol or propylene glycol, yet which exhibit excellent freeze-thaw stability, and in the meantime maintain favorable wet scrub resistance to the latex coating compositions prepared therefrom.

The anionic monomer M1 comprises at least one ethylenically unsaturated bond and at least one anion. Without being bound by theory, it is believed that polymer particles having negative charge will attempt to repel each other, thus are less tend to aggregate to form coagulum, therefore are more stable in formulation. The anionic monomer M1 comprises at least one ethylenically unsaturated bond, thus can be incorporated into the structure of the polymer. In the meantime, the anions are also introduced to the structure of the polymer particles, thereby improve the stability of the polymer dispersions.

In one embodiment of the present invention, the anionic monomer M1 is the one or more selected from sulfonate, sulfate, phosphate, acetate, isethionate comprising at least one ethylenically unsaturated bond, or the combination thereof, notably the anionic ion is selected from sulfonate, sulfate, phosphate, acetate, isethionate anion.

In one embodiment of the present invention, the anionic monomer M1 is selected from 1-allyloxy-2-hydroxypropane sulfonate salt, 2-acrylamido-2-methylpropanesulfonic acid salt, allyl ether phosphate salt, or the combination thereof.

In one embodiment of the present invention, the anionic monomer M1 presents in an amount ranging from 0.1 to 0.5 wt. %, preferably 0.2 to 0.4 wt. %, based on the total weight of the latex polymer.

In the present invention, the alkoxylated (meth)acrylate monomer M2 represent by formula I)

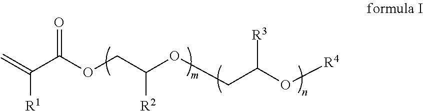

wherein R¹ is selected from H or methyl;
R² is selected from H, C₁-C₄ alkyl;
R³ is selected from C₁-C₄ alkyl, and R² is different from R³;
R⁴ is selected from C₆-C₂₀ alkyl, or C₆-C₂₀ alkenyl, preferably selected from C₈-C₂₀ alkyl or C₆-C₂₀ alkenyl, more preferably C₁₀-C₂₀ alkyl or C₆-C₂₀ alkenyl;
m is a number ranging from 15 to 60, preferably 20 to 60, more preferably 25 to 60;
n is a number ranging from 0 to 10, preferable 0 to 5, more preferably 0 to 3;
m+n is a number ranging from 15 to 60.

In one embodiment of the present invention, one of R² and R³ is selected from H, the other is selected from methyl.

In one embodiment of the present invention, R³ is selected from methyl.

In one embodiment of the present invention, R⁴ is selected from C₆-C₂₀ alkyl which could be straight or branched, notably an alkyl having carbon atoms of 6, 7, 8, 9, 10, 11, 12, 13, 14, 15, 16, 17, 18, 19, or 20. Preferably, R⁴ is selected from C₈-C₂₀ alkyl, more preferably C₁₀-C₂₀ alkyl.

In another embodiment of the present invention, R⁴ is selected from C₆-C₂₀ alkenyl which could be straight or branched, notably an alkenyl having carbon atoms of 6, 7, 8, 9, 10, 11, 12, 13, 14, 15, 16, 17, 18, 19, or 20. Preferably, R⁴ is selected from C₈-C₂₀ alkenyl, more preferably C₁₀-C₂₀ alkenyl.

In one embodiment of the present invention, R⁴ is selected from hexyl, heptyl, octyl, nonyl, decyl, iso-decyl, undecyl, dodecyl, tridecyl, iso-tridecyl tetradecyl, pentadecyl, hexadecyl, heptadecyl, octadecyl, nonadecyl, eicosyl, docosyl, and behenyl.

In another embodiment of the present invention, the alkoxyl oxide chain of the functional monomer has a length of 15 to 60, meaning m+n is a number ranging from 15 to 60.

As interpreted by the person skilled in the art, the block of —(CHR²—O)ₘ— and —(CHR³—O)ₙ— represents ethylene oxide (EO) unit and propylene oxide (PO) unit respectively, and they can link to the (meth)acrylate moiety interchangeably, randomly or in block.

The alkoxylated (meth)acrylate monomer M2 can be commercial available or prepared by the conventional process, such as esterification process of (meth)acrylate and alkoxylated fatty alcohol.

According to any one of the invention embodiments, the amount of the alkoxylated (meth)acrylate monomer can be vary in different application, such as 0.1 to 5 wt. %, preferably 0.5 to 3 wt. %, more preferably 0.7 to 2.5 wt. %, based on the total weight of the latex polymer.

The ethylenically unsaturated monomer can be those suitable for preparing latex binders in the art, including but not limited to pure acrylics (comprising acrylic acid, methacrylic acid, acrylate ester, and/or methacrylate ester as the main monomers); styrene acrylics (comprising styrene and acrylic acid, methacrylic acid, acrylate ester, and/or methacrylate ester as the main monomers); vinyl acetate-acrylic co-polymers (comprising vinyl acetate and one or more selected from acrylic acid, methacrylic acid, acrylate ester and methacrylate ester, as the main monomers); and vinyl acetate-ethylene-acrylic co-polymers (comprising ethylene, vinyl acetate, and one or more selected from acrylic acid, methacrylic acid, acrylate ester and methacrylate ester, as the main monomers). Accordingly, the ethylenically unsaturated monomers contemplated in the present invention include but not limited to acrylic acid, methacrylic acid, acrylate ester, methacrylate ester, styrene, vinyl acetate, C₄-C₈ conjugated dienes (comprising 1,3-butadiene, isoprene and chloroprenea methyl styrene), vinyl chloride, acrylonitrile, methacrylonitrile, ureido methacrylate, itaconic acid or ester, crotonic acid or ester, maleic acid or ester, fumaric acid or ester, and ethylene. Typically, the monomers include one or more monomers selected from the group consisting of n-butyl acrylate, methyl methacrylate, styrene and 2-ethylhexyl acrylate, vinyl acetate.

The free radical polymerization of the latex polymer dispersion can be accomplished by known procedures for polymerization, particularly in aqueous emulsion. Optionally, conventional seeding procedures can be employed to aid in controlling polymerization to achieve the desired average particle size and particle size distribution. If seeding is employed, the polymer seed will be present in amounts that correspond to about 0.1% to 8% by weight of the total polymer, and will range in size from about 20% to 60% of the diameter of the polymer particles to be formed.

The seed latex can constitute a previously prepared latex or polymer powder, or it can be prepared in situ. The monomeric composition of the seed latex can vary; however, it is preferable that it be substantially the same as that of the polymer.

The monomer or comonomers and, optionally, the seed to be employed in the preparation of the polymer, are dispersed into water with agitation sufficient to emulsify the mixture. The aqueous medium may also contain a free radical polymerization catalyst, an emulsifying agent (i.e., surfactant), or other ingredients that are known and conventionally employed in the art as emulsion polymerization aids.

Suitable free radical polymerization catalysts are the catalysts known to promote emulsion polymerization and include water-soluble oxidizing agents, such as, organic peroxides (e.g., t-butyl hydroperoxide, cumene hydroperoxide, etc.), inorganic oxidizing agents (e.g., hydrogen peroxide, potassium persulfate, sodium persulfate, ammonium persulfate, etc.) and those catalysts that are activated in the water phase by a water-soluble reducing agent. Such catalysts are employed in a catalytic amount sufficient to cause polymerization. As a general rule, a catalytic amount ranges from about 0.1 to 5 pphm. As alternatives to heat or catalytic compounds to activate the polymerization, other free radical producing means, such as exposure to activating radiation, can be employed.

Suitable emulsifying agents include anionic, cationic, and nonionic emulsifiers customarily used in emulsion polymerization. Usually, at least one anionic emulsifier is utilized and one or more nonionic emulsifiers may also be utilized. Representative anionic emulsifiers are the alkyl aryl sulfonates, alkali metal alkyl sulfates, the sulfonated alkyl esters, and fatty acid soaps. Specific examples include sodium dodecylbenzene sulfonate RHODACAL® DS-4, sodium butylnaphthalene sulfonate, sodium lauryl sulfate, disodium dodecyl diphenyl ether disulfonate, N-octadecyl disodium sulfosuccinate and dioctyl sodium sulfosuccinate. The emulsifying agents are employed in amounts to achieve adequate emulsification and to provide desired particle size and particle size distribution.

Other ingredients known in the art to be useful for various specific purposes in emulsion polymerization, such as, acids, salts, chain transfer agents, and chelating agents, can also be employed in the preparation of the polymer. For example, if the polymerizable constituents include a monoethylenically unsaturated carboxylic acid monomer, polymerization under acidic conditions (pH 2 to 7, preferably 2 to 5) is preferred. In such instances, the aqueous medium can include those known weak acids and their salts that are commonly used to provide a buffered system at the desired pH range.

The manner of combining the polymerization ingredients can be by various known monomer feed methods, such as, continuous monomer addition, incremental monomer addition, or addition in a single charge of the entire amount of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

Polymerization is initiated by heating the emulsified mixture with continued agitation to a temperature usually between about 50 to 100° C., preferably between 60 to 100° C. Polymerization is continued by maintaining the emulsified mixture at the selected temperature until conversion of the monomer or monomers to polymer has been reached.

Following polymerization, the solids content of the resulting aqueous heterogeneous polymer latex can be adjusted to the level desired by the addition of water or by the removal of water by distillation. Generally, the desired level of polymeric solids content is from about 20 to 60% by weight on a total weight basis.

The latex polymer dispersion typically includes from about 30 to about 75% solids and a mean latex particle size of from about 70 to about 650 nm. In another embodiment, the latex polymer of the present invention has a mean particle size of less than about 400 nm, typically a mean particle size of less than about 200 nm, more typically a mean particle size of less than about 190 nm, and most typically a mean particle size of less than about 175 nm. In another embodiment, the latex polymer has a mean particle size of from about 75 nm to about 400 nm.

The latex polymer dispersion typically has a viscosity of ranging from 10 to 10000 mPa·s, preferably from 10 to 6000 mPa·s, more preferably from 10 to 3000 mPa·s, determined according to Brookfield viscosity (RVT) at room temperature with a Spindle 3.

For various applications, it is sometimes desirable to have small amounts of additives, such as, surfactants, bactericides, pH modifiers, and antifoamers, incorporated in the latex. This may be done in a conventional manner and at any convenient point in the preparation of the latexes.

### The Coating Composition

In another aspect of the present invention, it is provide an aqueous coating composition. The aqueous coating composition of the present invention has improved freeze thaw stability without adding volatile freeze-thaw additives, in the meantime, the wet scrub resistance are maintained.

The aqueous coating composition of the present invention comprises a latex binder polymer prepared from the monomer composition comprising:
a) an anionic monomer M1 comprising at least one ethylenically unsaturated bond and at least one anion;
b) an alkoxylated (meth)acrylate monomer M2 represent by formula I)

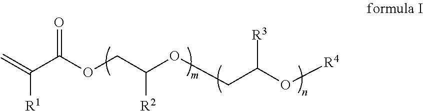

wherein R¹ is selected from H or methyl;
R² is selected from H, C₁-C₄ alkyl;
R³ is selected from C₁-C₄ alkyl, and R² is different from R³;
R⁴ is selected from C₆-C₂₀ alkyl, or C₆-C₂₀ alkenyl, preferably selected from C₈-C₂₀ alkyl or C₆-C₂₀ alkenyl, more preferably C₁₀-C₂₀ alkyl or C₆-C₂₀ alkenyl;
m is a number ranging from 15 to 60, preferably 20 to 60, more preferably 25 to 60;
n is a number ranging from 0 to 10, preferable 0 to 5, more preferably 0 to 3;
m+n is a number ranging from 15 to 60; and
c) an ethylenically unsaturated monomer selected from acrylic acid, methacrylic acid, acrylate ester, methacrylate ester, styrene, vinyl acetate, C₄-C₈ conjugated dienes, vinyl chloride, acrylonitrile, methacrylonitrile, ureido methacrylate, itaconic acid or ester, crotonic acid or ester, maleic acid or ester, fumaric acid or ester, and ethylene or the combination thereof.

The aqueous coating composition of the present invention formulated using techniques known to those skilled in the art of manufacturing coating composition from the latex binder polymer as illustrated above.

In one embodiment of the present invention, the latex binder polymer is added into the aqueous composition as an emulsion as illustrated above, and is typically present in the aqueous coating composition in an amount from 2.5 to 30 wt. %, and more preferably from 3.5 to 20 wt. %, based on the total weight of the aqueous coating composition.

In one embodiment of the present invention, the latex binder polymer is selected from pure acrylics polymer; styrene acrylics polymer; vinyl acetate-acrylic co-polymers; and vinyl acetate-ethylene-acrylic co-polymers.

The aqueous coating composition typically includes at least one pigment. The term “pigment” as used herein includes non-film-forming solids such as pigments, extenders, and fillers. The at least one pigment is typically selected from the group consisting of TiO₂ (in both anastase and rutile forms), clay (aluminum silicate), CaCO₃ (in both ground and precipitated forms), aluminum oxide, silicon dioxide, magnesium oxide, talc (magnesium silicate), barytes (barium sulfate), zinc oxide, zinc sulfite, sodium oxide, potassium oxide and mixtures thereof. Suitable mixtures include blends of metal oxides such as those sold under the marks MINEX (oxides of silicon, aluminum, sodium and potassium commercially available from Unimin Specialty Minerals), CELITES (aluminum oxide and silicon dioxide commercially available from Celite Company), ATOMITES (commercially available from English China Clay International), and ATTAGELS (commercially available from Engelhard). More typically, the at least one pigment includes TiO₂, CaCO₃ or clay. Generally, the mean particle sizes of the pigments range from about 0.01 to about 50 microns. For example, the TiO₂ particles used in the aqueous coating composition typically have a mean particle size of from about 0.15 to about 0.40 microns. The pigment can be added to the aqueous coating composition as a powder or in slurry form. The pigment is typically present in the aqueous coating composition in an amount from about 5 to about 50 percent by weight, more typically from about 10 to about 40 percent by weight.

In various embodiments of the present invention, the aqueous coating composition has a PVC of from 10% to 90%, from 30 to 85%, or from 50 to 85%. The coating composition of the present invention has improved freeze thaw stability while maintained wet scrub resistance at various PVC content.

PVC of a coating a composition may be determined according to the following equation:

$$PVC = \frac{pigment volume + extender volume}{pigment volume + extender volume + binder volume} * 100 \%$$

The aqueous coating composition can optionally contain additives such as one or more film-forming aids or coalescing agents. Suitable film-forming aids or coalescing agents include plasticizers and drying retarders such as high boiling point polar solvents. Other conventional coating additives such as, for example, dispersants, additional surfactants (i.e. wetting agents), rheology modifiers, defoamers, thickeners, biocides, mildewcides, colorants such as colored pigments and dyes, waxes, perfumes, co-solvents, and the like, can also be used in accordance with the invention. For example, non-ionic and/or ionic (e.g. anionic or cationic) surfactants can be used to produce the polymer latex. These additives are typically present in the aqueous coating composition in an amount from 0 to about 15% by weight, more typically from about 1 to about 10% by weight based on the total weight of the aqueous coating composition.

In some embodiments, the aqueous coating composition can include less than 2.0% of VOC agents based on the total weight of the aqueous coating composition. Exemplary agents include ethylene glycol, diethylene glycol, propylene glycol, glycerol (1,2,3-trihydroxypropane), ethanol, methanol, 1-methoxy-2-propanol, 2-amino-2-methyl-1-propanol, and FTS-365 (a freeze-thaw stabilizer from Inovachem Specialty Chemicals). More typically, the aqueous coating composition includes less than 1.0% or is substantially free (e.g. includes less than 0.1%) of volatile freeze-thaw additives. Accordingly, the aqueous coating composition of the invention typically has a VOC level of less than about 100 g/L and more typically less than or equal to about 50 g/L.

The balance of the aqueous coating composition of the invention is water. Although much of the water is present in the polymer latex polymer dispersion and in other components of the aqueous coating composition, water is generally also added separately to the aqueous coating composition. Typically, the aqueous coating composition includes from about 10% to about 85% by weight and more typically from about 35% to about 80% by weight water. Stated differently, the total solids content of the aqueous coating composition is typically from about 15% to about 90%, more typically, from about 20% to about 65%.

The aqueous coating composition is typically formulated such that the dried coatings comprise at least 10% by volume of dry polymer solids, and additionally 5 to 90% by volume of non-polymeric solids in the form of pigments. The dried coatings can also include additives such as plasticizers, dispersants, surfactants, rheology modifiers, defoamers, thickeners, biocides, mildewcides, colorants, waxes, and the like, that do not evaporate upon drying of the aqueous coating composition.

### The Coated Article

In still another aspect of the present invention, it is provided a coated article prepared by applying the aqueous coating composition as illustrated above onto a substrate.

The aqueous coating composition may be applied by conventional application methods such as, for example, brushing, roller application, and spraying methods such as, for example, air-atomized spray, air-assisted spray, airless spray, high volume low pressure spray, and air-assisted airless spray.

Suitable substrates include, but not limited to, for example, concrete, cement board, MDF and particle board, gypsum board, wood, stone, metal, plastics, wall paper and textile, etc. preferably, all the substrate are pre-primed by waterborne or solvent borne primers.

The disclosure is further described in the following examples. The examples are merely illustrative and do not in any way limit the scope of the disclosure as described and claimed.

Should the disclosure of any patents, patent applications, and publications which are incorporated herein by reference conflict with the description of the present application to the extent that it may render a term unclear, the present description shall take precedence.

### Examples

### 1. Materials

Rhodapex LA40S-Z: anionic emulsifier, commercial available from Solvay;
ABEX AP470-Z: non-ionic emulsifier, commercial available from Solvay;
Texanol, coalescent agent, commercial available from EASTMAN Co., Ltd.
Acrysol TT-935, thickener, commercial available from DOW Co., Ltd.
Rhodaline DF 681F, defoamer, commercial available from Solvay Co., Ltd.
Rhodaline WA 2809, defoamer, commercial available from Solvay Co., Ltd
Rhodaline WA 2809, wetting agent, commercial available from Solvay Co., Ltd
Natrosol 250HBR, thickener, commercial available from Ashland Co., Ltd
AMPTM 95, neutralization agent, commercial available from ANGUS chemical company
Rhodaline 111, dispersant agent, commercial available from Solvay Co., Ltd
Ti-Pure R-706, pigment, commercial available from DUPONT Co., Ltd.
DB-80, filler, commercial available from Shanxi Bright Kaolin Technology Co. Ltd.
Talc MS-1250, filler, commercial available from Guangfu Bulding Materials (Jiaoling) fine chemicals Industry Co., Ltd.
CC-700, filler, commercial available from Guangfu Bulding Materials (jiaoling) fine chemicals Industry Co., Ltd.
Kathon CG, biocide, commercial available from DUPONT Co., Ltd.
Specialty monomers: Sodium allyloxy hydroxypropyl sulfonate (M1-1), Allyl ether phosphate ammonium salt (M1-3), 2-acrylamido-2-methylpropanesulfonic acid sodium salt (M1-4), Allyl alcohol ethoxylate (M1-5), alkoxylated methacrylate monomer (M2-1), are from Solvay

### 2. Preparation of the Latex Polymer Dispersion Composition

The latex polymer dispersion was prepared according to the process below:
Firstly, a monomer emulsion (ME) was prepared by mixing of deionized (DI) water, Rhodapex LA40S-Z, styrene (ST), Butyl Acrylate (BA), Acrylic Acid (AA), and/or alkoxylated (meth)acrylate monomer M2.
Secondly, in a 3 L vessel equipped with a reflux condenser and a stirrer, DI water was added at an agitation rate of 120 revolutions per minute (rpm). The temperature of the reaction vessel was raised to 80° C. Then Rhodapex LA40S-Z surfactant (31%) and anionic monomer M1 if there is were introduced into the reaction vessel.
Thirdly, ME, an initiator solution consisting of Ammonium Persulfate (APS) and DI water were injected into the reaction vessel. The reaction mixture was held at a temperature between 78 and 82° C. for 15 minutes. Thereafter, the remainder of ME was added into the reaction vessel over the span of 210 minutes. During addition of ME, another initiator solution consisting of APS and DI water were co-fed into the reaction vessel over the span of 210 minutes.
After the ME and initiator feeding, the reactor temperature was held at somewhere between 78 to 82° C. for another 30 min.
Then the reaction vessel was cooled down to 70° C. A reductant solution consisting of Isoascorbic Acid (IAA) and DI water, and an initiator solution consisting of t-BHP 70% solution, were injected into the reaction vessel respectively and hold at 70° C. for 30 min then cooling to room temperature.
Finally, an adjustable amount of Ammonia solution was added to the resultant dispersion to keep the pH between 7.5 and 8.5 when the temperature had reached 50° C. The aqueous emulsion in the obtained had a solid content of 44.0-46.0%.

The following latex polymer dispersion were obtained, and the parameters were determined as below. “S” refers to the examples of the present invention, “CS” refers to the comparative example.
% oven solids: Weigh 1 g of the latex in aluminum dish and dried in the oven for 1 hour (till dried). An average result will be taken from two samples' readings.
pH: measured with the calibrated pH meter.
Brookfield viscosity (RVT/LVT): Measured with the RVT/LVT viscometer (RVT/LVT), Spindle 3, (10 rpm/60 rpm)

As shown by CS2, only monomer M2 will result a latex with higher coagulum, meaning less reaction stability. CS3 was prepared from a non-ionic monomer, it has high coagulum and lower storage stability. However, this can be overcome by combining the use of monomer M1 which are proved by S1 to S3 of the present invention.

TABLE 1
the latex polymer dispersion and the properties thereof

| | CS1 | CS2 | CS3 | S1 | S2 | S3 |
|---|---|---|---|---|---|---|
| Deionised Water | 55.5 | 55.5 | 55.5 | 55.5 | 55.5 | 55.5 |
| Rhodapex LA40S-Z solids | 1.2 | 1.2 | 1.2 | 1.2 | 1.2 | 1.2 |
| ABEX AP470Z solids | 0.5 | 0.5 | 0.5 | 0.5 | 0.5 | 0.5 |

Monomer composition

| | | | | | | |
|---|---|---|---|---|---|---|
| Styrene (S) | 49.7 | 49.7 | 49.7 | 49.7 | 49.7 | 49.7 |
| Butyl Acrylate (BA) | 46.5 | 46.5 | 46.5 | 46.5 | 46.5 | 46.5 |
| Acrylic Acid (AA) | 2.1 | 2.1 | 2.1 | 2.1 | 2.1 | 2.1 |
| Monomer M1 | 0.3 | 0 | 0.3 | 0.3 | 0.3 | 0.3 |
| | M1-1 | | M1-5 | M1-1 | M1-3 | M1-4 |
| Monomer M2 | 0 | 1.4 | 1.4 | 1.4 | 1.4 | 1.4 |
| | | M2-1 | M2-1 | M2-1 | M2-1 | M2-1 |
| Ammonium Persulfate | 0.8 | 0.8 | 0.8 | 0.8 | 0.8 | 0.8 |
| Tert-butyl Hydroperoxide | 0.1 | 0.1 | 0.1 | 0.1 | 0.1 | 0.1 |
| Isoascorbic Acid | 0.1 | 0.1 | 0.1 | 0.1 | 0.1 | 0.1 |
| Ammonium Hydroxide | 0.3 | 0.3 | 0.3 | 0.3 | 0.3 | 0.3 |
| % oven solids (145° C. for 2 hr) | 45.65 | 44.72 | 45.39 | 45.28 | 45.02 | 45.53 |
| pH (as it) | 8.02 | 8.06 | 8.02 | 8.22 | 8.05 | 8.01 |
| Brookfield viscosity (mPa · s) | 65 | 22 | 32 | 26 | 32 | 38 |
| Coagulum, ppm | 702 | 3999 | 2908 | 673 | 741 | 846 |
| Latex storage stability, 2 month, R.T. | Y | Y | N | Y | Y | Y |

### 3. Preparation of the Aqueous Coating Formulation

The aqueous coating formulations having a PVC of 42%, 62%, 72% and 82% were prepared as followings:
Ingredients for the grind as listed in the following tables were mixed under high shear for 30 minutes (2000 rpm);
All ingredients in the letdown were added to the mixture and mixed for 30 minutes (800 rpm).

TABLE 2
Paint Formulation 42 PVC

| | |
|---|---|
| Raw materials | Weight Percent |

Pigment Grind

| | |
|---|---|
| Water | 15.00 |
| PG | 0.00 |
| Natrosol 250HBR | 0.30 |
| Ammonia, 25% | 0.25 |
| KuaiYi | 0.50 |
| Rhodoline 2809 | 0.10 |
| Rhodoline DF681F | 0.15 |
| Tronox CR-826 | 22.00 |
| Calcined Clay DB80 | 4.00 |
| Imercarb 3 | 10.00 |
| Water | 1.00 |
| Subtotal | 53.30 |

Letdown

| | |
|---|---|
| Water | 6.80 |
| Latex (45%) | 35.20 |
| DF 681F | 0.15 |
| Texanol | 1.80 |
| Kathon CG | 0.10 |
| Acrysol TT-935 | 0.00 |
| Water | 2.65 |
| Total | 100.00 |

TABLE 3
Paint Formulation 62 PVC

| | |
|---|---|
| Raw materials | Weight Percent |

Pigment Grind

| | |
|---|---|
| Water | 22.00 |
| PG | 0.00 |
| Natrosol 250HBR | 0.45 |
| Ammonia, 25% | 0.25 |
| KuaiYi | 0.40 |
| Rhodoline 2809 | 0.10 |
| Rhodoline DF681F | 0.15 |
| Tronox CR-826 | 15.00 |
| Calcined Clay DB80 | 5.00 |
| Talc 800 | 7.00 |
| Imercarb 3 | 15.00 |
| Water | 1.00 |
| Subtotal | 66.35 |

Letdown

| | |
|---|---|
| Water | 9.73 |
| Latex (45%) | 20.27 |
| DF 681F | 0.15 |
| Texanol | 1.00 |
| Kathon CG | 0.10 |
| Acrysol TT-935 | 0.00 |
| Water | 2.40 |
| Total | 100.00 |

TABLE 4
The aqueous Formulation 72 PVC

| | |
|---|---|
| Raw materials | Weight Percent |

Pigment Grind

| | |
|---|---|
| DI Water | 23.80 |
| Propylene Glycol (PG) | 0.00 |
| Natrosol ® 250HBR | 0.50 |
| AMP ™ 95 | 0.15 |
| Rhodaline 111 | 0.50 |
| Rhodoline 2809 | 0.10 |
| Rhodaline DF 681F | 0.15 |
| Ti-Pure R-706 | 10.53 |
| DB-80 | 4.00 |
| Talc MS-1250 | 7.00 |
| CC-700 | 28.50 |
| DI Water | 1.00 |
| Sub total | 76.23 |

Letdown

| | |
|---|---|
| DI Water | 5.25 |
| Latex polymer ((48% solid | 14.50% |
| content)) | |
| Rhodaline DF 681F | 0.15 |
| Texanol | 0.80 |
| Kathon CG | 0.10 |
| Acrysol TT-935 (1:1 DI water) | 0.70 |
| DI Water | 2.27 |
| Total | 100.00 |

TABLE 5
Paint Formulation 82 PVC

| | |
|---|---|
| Raw materials | Weight Percent |

Pigment Grind

| | |
|---|---|
| Water | 27.00 |
| PG | 0.00 |
| Natrosol 250HBR | 0.60 |
| Ammonia, 25% | 0.25 |
| KuaiYi | 0.50 |
| Rhodoline 2809 | 0.10 |
| Rhodoline DF681F | 0.15 |
| Tronox CR-826 | 5.00 |
| Calcined Clay DB80 | 4.00 |
| Talc 800 | 7.50 |
| Imercarb 3 | 32.00 |
| Water | 1.00 |
| Subtotal | 78.10 |

Letdown

| | |
|---|---|
| Water | 2.08 |
| Latex (45%) | 9.07 |
| DF 681F | 0.15 |
| Texanol | 0.50 |
| Kathon CG | 0.10 |
| Acrysol TT-935 (1:1 DI water) | 0.00 |
| Water | 10.00 |
| Total | 100.00 |

### Freeze-Thaw Stability Test Method

Test samples (in a glass container) were placed in Dynamic climate chamber (Binder MK53) programmed at −7° C. for 16 hours and then allowed to thaw for 6 hours at 23° C. for total of 3 cycles. The viscosity (RVT, Spindle 05, 30 rpm, 1 min, mPa·s) thereof was measured at the end of 3 cycles.

The difference between the initial and final viscosity is reported as the viscosity change in mPa·s (delta mPa·s). If the sample does not coagulate or shows no big grits separated from the sample after the freeze-thaw test, at the same time, shows viscosity change no more than 2000 mPa·s, the sample is identified as good freeze-thaw stability. Otherwise, if the sample gets gelled or has big grits separated, or showing viscosity change higher than 2000 mPa·s, which indicates the poor freeze-thaw stability.

### Scrub Resistance Test Method

The scrub resistance was determined according to GBT/9266-2009. A formulated paint was cast with a 150 μm film caster on the substrate, and then dried in a horizontal position for 7 days in a Constant Temperature Room (CTR, 23+2° C. and 50+−5% relative humidity). The scrub test was performed on a Sheen machine Model REF903 equipped with a metal tray and nylon bristle brush. A brush was soaked in water overnight before use, and was then mounted in a brush holder with the brush's bustle-side down to start the test. 0.5% SLS solution were applied on brush surface. The number of cycles needed to completely remove the coating film in one continuous line was recorded. The number of cycles for the coating composition of Example CS2 was recorded as 100%, and the number of cycles for other examples were relative percentage values compared to that of Example CS2. A relative percentage between 80%-120% means acceptable scrub resistance. Higher relative percentage means better wet scrub resistance.

As shown by tables 6 to 9, the coating compositions of the present invention has improved free thaw stability while wet scrub resistance is maintained at each PVC content.

TABLE 6
the performance of the coating composition 42 PVC

| | Coating Composition | | | | | |
|---|---|---|---|---|---|---|
| | CS4 | CS5 | CS6 | S4 | S5 | S6 |
| Latex polymer dispersion | CS1 | CS2 | CS3 | S1 | S2 | S3 |
| Viscosity, Initial, KU | 101.1 | 91.4 | 94 | 91.5 | 91 | 90.2 |
| Viscosity, equilibrium, | 103.4 | 93.5 | 94.1 | 92.1 | 91.9 | 90.9 |
| KU | | | | | | |

Freeze-Thaw Stability

| | | | | | | |
|---|---|---|---|---|---|---|
| Viscosity, Initial, mPa · s | 5467 | 4227 | 4640 | 4373 | 4293 | 4000 |
| Viscosity, 3 cycles, mPa · s | 10000* | 4320 | 5133 | 5280 | 4227 | 5240 |
| Delta viscosity | 4553 | 93 | 493 | 907 | −66 | 1240 |

Wet Scrub Resistance

| | | | | | | |
|---|---|---|---|---|---|---|
| % Cut through | 84 | 100 | 110 | 97 | 97 | 92 |

TABLE 7
the performance of the coating composition 62 PVC

| | Coating Composition | | | | | |
|---|---|---|---|---|---|---|
| | CS4 | CS5 | CS6 | S4 | S5 | S6 |
| Latex polymer dispersion | CS1 | CS2 | CS3 | S1 | S2 | S3 |
| Viscosity, Initial, KU | 90.9 | 91.6 | 92 | 93.5 | 92.2 | 93.3 |
| Viscosity, equilibrium, | 92.5 | 92.6 | 94.4 | 95.7 | 93.5 | 93.6 |
| KU | | | | | | |

Freeze-Thaw Stability

| | | | | | | |
|---|---|---|---|---|---|---|
| Viscosity, Initial, mPa · s | 3720 | 3587 | 3787 | 3960 | 3880 | 3787 |
| Viscosity, 3 cycles, mPa · s | 10000* | 5720 | 5240 | 6227 | 4387 | 6107 |
| Delta viscosity | 6280 | 2133 | 1453 | 2267 | 507 | 2320 |

Wet Scrub Resistance

| | | | | | | |
|---|---|---|---|---|---|---|
| % Cut through | 102 | 100 | 117 | 102 | 105 | 109 |

TABLE 8
the performance of the coating composition 72 PVC

| | Coating Composition | | | | | |
|---|---|---|---|---|---|---|
| | CS4 | CS5 | CS6 | S4 | S5 | S6 |
| Latex polymer dispersion | CS1 | CS2 | CS3 | S1 | S2 | S3 |
| Viscosity, Initial, KU | 94.7 | 91.6 | 91.2 | 90.9 | 91.3 | 92 |
| Viscosity, equilibrium, | 95.4 | 92 | 88.4 | 88.8 | 89.2 | 90.8 |
| KU | | | | | | |

Freeze-Thaw Stability

| | | | | | | |
|---|---|---|---|---|---|---|
| Viscosity, Initial, mPa · s | 4253 | 3773 | 3547 | 3480 | 3600 | 3493 |
| Viscosity, 3 cycles, mPa · s | *10000 | 5213 | 4387 | 4240 | 3307 | 4280 |
| Delta viscosity | 5747 | 1440 | 840 | 760 | −293 | 787 |

Wet Scrub Resistance

| | | | | | | |
|---|---|---|---|---|---|---|
| % Cut through | 101 | 100 | 95 | 73 | 91 | 107 |

TABLE 9
the performance of the coating composition 82 PVC

| | Coating Composition | | | | | |
|---|---|---|---|---|---|---|
| | CS4 | CS5 | CS6 | S4 | S5 | S6 |
| Latex polymer dispersion | CS1 | CS2 | CS3 | S1 | S2 | S3 |
| Viscosity, Initial, KU | 94.6 | 92 | 91.6 | 89.4 | 90.1 | 90.9 |
| Viscosity, equilibrium, | 94.8 | 92.9 | 92.8 | 90.9 | 91.9 | 90.3 |
| KU | | | | | | |

Freeze-Thaw Stability

| | | | | | | |
|---|---|---|---|---|---|---|
| Viscosity, Initial, | 4627 | 4293 | 3653 | 3680 | 2987 | 3800 |
| mPa · s | | | | | | |
| Viscosity, 3 cycles, | 10000* | 7347 | 3093 | 4280 | 3427 | 5533 |
| mPa · s | | | | | | |
| Delta viscosity | 5373 | 3054 | −560 | 600 | −440 | 1733 |

Wet Scrub Resistance

| | | | | | | |
|---|---|---|---|---|---|---|
| % Cut through | 113 | 100 | 107 | 116 | 95 | 110 |

1. A latex polymer dispersion prepared by free radical polymerization from a monomer composition comprising:
a) an anionic monomer M1 comprising at least one ethylenically unsaturated bond and at least one anion;
b) an alkoxylated (meth)acrylate monomer M2 represent by formula I) 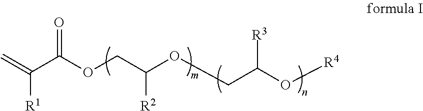
wherein R¹ is selected from H or methyl;
R² is selected from H, C₁-C₄ alkyl;
R³ is selected from C₁-C₄ alkyl, and R² is different from R³;
R⁴ is selected from C₆-C₂₀ alkyl, or C₆-C₂₀ alkenyl;
m is a number ranging from 15 to 60;
n is a number ranging from 0 to 10;
m+n is a number ranging from 15 to 60; and
c) an ethylenically unsaturated monomer selected from acrylic acid, methacrylic acid, acrylate ester, methacrylate ester, styrene, vinyl acetate, C₄-C₈ conjugated dienes, vinyl chloride, acrylonitrile, methacrylonitrile, ureido methacrylate, itaconic acid or ester, crotonic acid or ester, maleic acid or ester, fumaric acid or ester, and ethylene, or combinations thereof.

2. The latex polymer dispersion according to claim 1, wherein the anionic monomer M1 is in an amount ranging from 0.1 to 0.5 wt. %, based on the total weight of the latex polymer.

3. The latex polymer dispersion according to claim 1, wherein the anionic monomer M1 is the one or more selected from sulfonate, sulfate, phosphate, acetate, isethionate salt comprising at least one ethylenically unsaturated bond.

4. The latex polymer dispersion according to claim 3, wherein the anionic monomer M1 is selected from 1-allyloxy-2-hydroxypropane sulfonate salt, 2-acrylamido-2-methylpropanesulfonic acid salt, allyl ether phosphate salt, or combinations thereof.

5. The latex polymer dispersion according to claim 1, wherein one of R² and R³ is selected from H, the other is selected from methyl.

6. The latex polymer dispersion according to claim 1, wherein R⁴ is selected from hexyl, heptyl, octyl, nonyl, decyl, iso-decyl, undecyl, dodecyl, tridecyl, iso-tridecyl tetradecyl, pentadecyl, hexadecyl, heptadecyl, octadecyl, nonadecyl, eicosyl, docosyl, and behenyl.

7. The latex polymer dispersion according to claim 1, wherein the ethylenically unsaturated monomer is selected from acrylic acid, methacrylic acid, acrylate ester, methacrylate ester, styrene, vinyl acetate, ethylene, C₄-C₈ conjugated dienes, or combinations thereof.

8. The latex polymer dispersion according to claim 1, wherein the alkoxylated (meth)acrylate monomer M2 presents in an amount ranging from 0.1 to 5 wt. %, based on the total weight of the latex polymer.

9. The latex polymer dispersion according to claim 1, wherein the latex polymer dispersion is prepared by emulsion polymerization.

10. An aqueous coating composition, comprising a latex binder polymer prepared from a monomer composition comprising:
a) an anionic monomer M1 comprising at least one ethylenically unsaturated bond and at least one anion;
b) an alkoxylated (meth)acrylate monomer M2 represent by formula I) 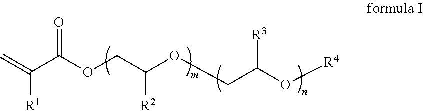
wherein R¹ is selected from H or methyl;
R² is selected from H, C₁-C₄ alkyl;
R³ is selected from C₁-C₄ alkyl, and R² is different from R³;
R⁴ is selected from C₆-C₂₀ alkyl, or C₆-C₂₀ alkenyl;
m is a number ranging from 15 to 60;
n is a number ranging from 0 to 10;
m+n is a number ranging from 15 to 60; and
c) an ethylenically unsaturated monomer selected from acrylic acid, methacrylic acid, acrylate ester, methacrylate ester, styrene, vinyl acetate, C₄-C₈ conjugated dienes, vinyl chloride, acrylonitrile, methacrylonitrile, ureido methacrylate, itaconic acid or ester, crotonic acid or ester, maleic acid or ester, fumaric acid or ester, and ethylene, or combinations thereof.

11. The aqueous coating composition according to claim 10, wherein the latex binder polymer is present in the aqueous coating composition in an amount from 2.5 to 30 wt. %, based on the total weight of the aqueous coating composition.

12. The aqueous coating composition according to claim 10, wherein the aqueous coating composition has a pigment volume concentration of 10% to 90%.

13. The aqueous coating composition according to claim 10, wherein the aqueous coating composition comprises less than 1.0 wt. % or is substantially free of volatile freeze-thaw additives, based on the total weight of the aqueous coating composition.

14. An Article comprising a substrate, wherein the article is prepared by applying the aqueous coating composition according to claim 10 onto the substrate.

15. A method of improving freeze thaw stability, while maintaining a wet scrub resistance, of an aqueous coating composition comprising incorporating the latex polymer dispersion according to claim 1 into the aqueous coating composition.

16. The latex polymer dispersion according to claim 1, wherein R⁴ is selected from C₈-C₂₀ alkyl, or C₆-C₂₀ alkenyl.

17. The latex polymer dispersion according to claim 1, wherein m is a number ranging from 20 to 60.

18. The latex polymer dispersion according to claim 1, wherein n is a number ranging from 0 to 5.

19. The latex polymer dispersion according to claim 1, wherein the anionic monomer M1 is in an amount ranging from 0.2 to 0.4 wt. %, based on the total weight of the latex polymer.

20. The latex polymer dispersion according to claim 1, wherein the alkoxylated (meth)acrylate monomer M2 presents in an amount ranging from 0.5 to 3 wt. %, based on the total weight of the latex polymer.
